(19) United States
(12) Patent Application Publication
(10) Pub. No.: US 2010/0224643 A1
(43) Pub. Date: Sep. 9, 2010

(54) Dispensing closure

(75) Inventor: Barry Michael Daggett, Austintown, OH (US)

Correspondence Address: TUROCY & WATSON, LLP, 127 Public Square, 57th Floor, Key Tower, CLEVELAND, OH, 44114, US

(73) Assignee: Weatherchem Corporation

(21) Appl. No.: 12/379,872

(22) Filed: Mar. 3, 2009

(51) Int. Cl. B65D 51/04; E05D 5/02

(52) U.S. Cl. 220/810; 16/387

(57) ABSTRACT

A dual action living hinge is disclosed. The dual action living hinge includes two hinge members flexibly interconnected by a connecting element. The hinge members are adapted to be folded about a geometric axis of the connecting element. The connecting element further contains a recession at each axial end along the geometric axis and a reinforced area in a center section along the geometric axis.

### FIELD OF THE INVENTION

The invention generally relates to dispensing closures and, in particular, to a dispensing closure with a dual-action living hinge.

### BACKGROUND

Dispensing closures for bottles, cans and other containers frequently have one or more flaps that can be pivoted between open and closed positions to conveniently dispense product from the container without removing the closure. The dispensing closures are typically made of plastics with a living hinge so that they can be produced as a single-piece structure by an injection molding process. The most fragile part of such structure is the living hinge, which is under considerable stress when the hinge is actuated. In addition, the living hinge generally protrudes from the outside peripheral of the enclosure when the flap is in a closed position, and is often damaged during use and transportation. Therefore, there exists a need for dispensing closures that are durable and can be produced at low cost.

### SUMMARY OF THE INVENTION

A dual action living hinge is disclosed. The dual action living hinge includes a first hinge member and a second hinge member flexibly interconnected by a connecting element. The first and second hinge members are adapted to be folded about a geometric axis of the connecting element. The connecting element includes a recession at each axial end along the geometric axis and a reinforced area in a center section along the geometric axis.

Also disclosed is a one-piece dispensing closure. The one-piece dispensing closure includes a base, a lid and a connecting element connecting the base to the lid. The connecting element includes a living hinge allowing the lid to move pivotally relative to the base along a geometric axis, recessions at each axial ends of the living hinge to reduce stress of hinge material, and a reinforced area in a center section along the geometric axis on the exterior side of the connecting element.

### BRIEF DESCRIPTION OF THE DRAWINGS

FIG. 1 is a top view of an embodiment of a one-piece dispensing closure with a dual action living hinge in an as-molded position.

FIG. 2 is a side view of the dispensing closure of FIG. 1 in an as-molded position.

FIG. 3 is a side view of the dispensing closure of FIG. 1 in a closed position.

FIG. 4 is a close-up view of the exterior side of the living hinge in the dispensing closure of FIG. 1.

FIG. 5 is a close-up view of the interior side of the living hinge in the dispensing closure of FIG. 1.

FIG. 6 is a close-up side view of the living hinge in the dispensing closure of FIG. 1.

### DESCRIPTION OF THE PREFERRED EMBODIMENTS

This description is intended to be read in connection with the accompanying drawings, which are to be considered part of the entire written description of this invention. The drawings are not necessarily to scale and certain features of the invention may be shown exaggerated in scale or in somewhat schematic form in the interest of clarity. In the description, relative terms such as “front,” “back,” “up,” “down,” “top” and “bottom,” as well as derivatives thereof, should be construed to refer to the orientation as then described or as shown in the drawing under discussion. These relative terms are for convenience of description and normally are not intended to require a particular orientation. Terms concerning attachments, coupling and the like, such as “connected” and “attached,” refer to a relationship wherein structures are secured or attached to one another either directly or indirectly through intervening structures, as well as both movable or rigid attachments or relationships, unless expressly described otherwise.

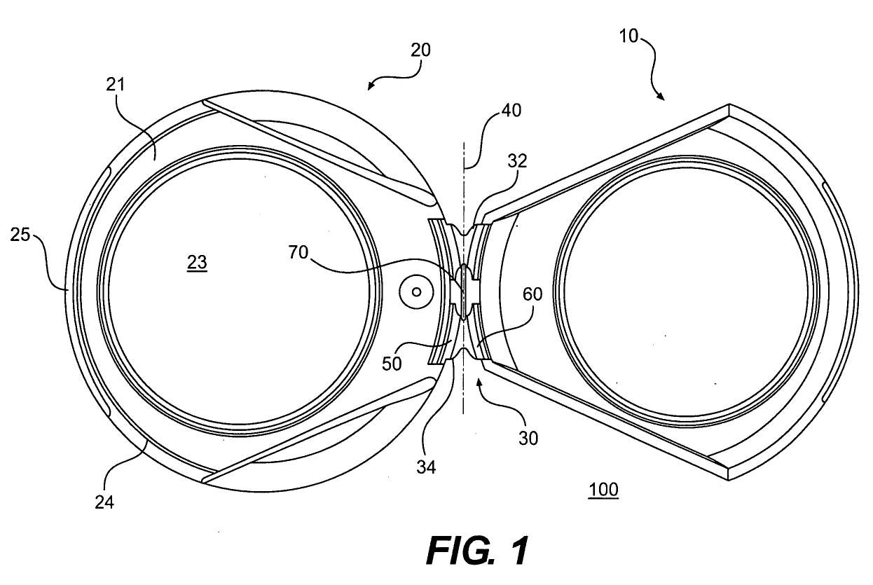

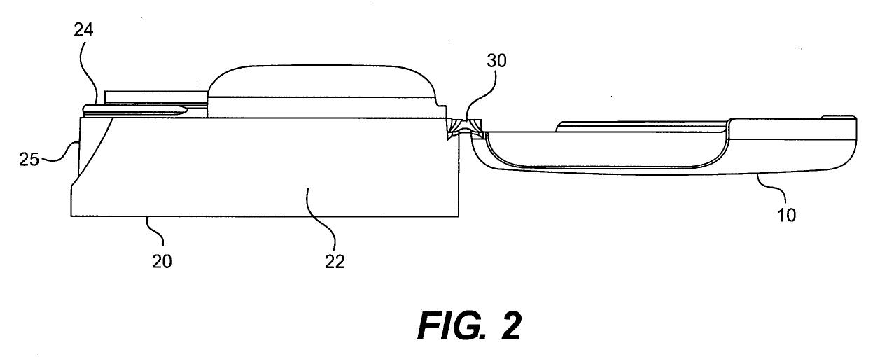

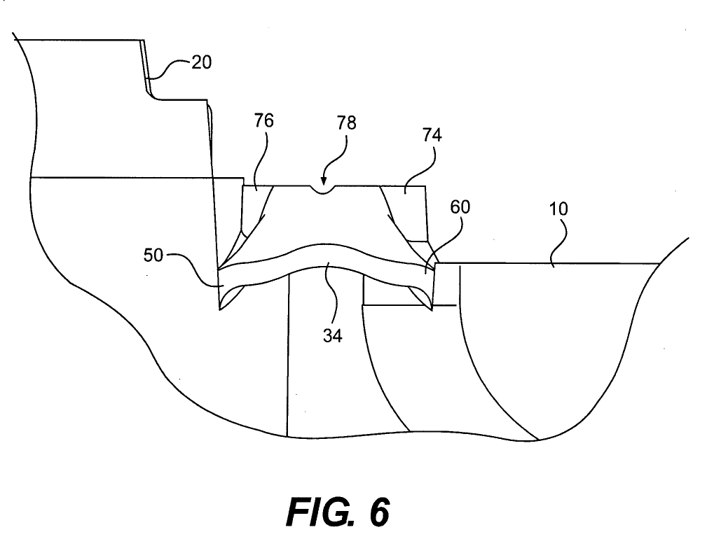

Referring now to FIGS. 1-6, there is shown an embodiment dual action living hinge 100. The living hinge comprises two hinge members 10 and 20, connected by a connecting element 30. The hinge member 10 constitutes a flap or lid for sealing the opening. The hinge member 20 constitutes the body or base of a dispensing disclosure and is adapted to be fitted on the opening of a container. The hinge members 10 can be folded against the hinge member 20 along a center line or a “geometric” main axis 40.

The term “living hinge” refers to a hinge integrally formed with two opposite portions of the same material. Typically the material along the living hinge is thin relative to the adjacent areas to facilitate flexing or bending of the opposite portions (i.e., the hinge members 10 and 20). A living hinge allows one portion to bend relative to the other portion, as would other hinges between the two portions. The living hinge 100 allows for a single piece design that can be molded as in-line of draw. No slides or sub-slides are required in the molding design.

The connecting element 30 are linked to the hinge members 10 and 20 by film hinges 50 and 60, respectively. Each film hinge 50 and 60 extends continuously from one axial end 32 of the connecting element 30 to the other axial end 34 of the connecting element 30 (FIG. 1). Each film hinge describes a spatial curve, which is pulled tight in a closed position and lies entirely or almost entirely in the cylinder wall of the closure. When viewed from the side, the film hinge 50 or 60 consists approximately of an arc of a circle. A main hinge 70 that directly interconnects the hinge members 10 and 20 is located on the center line or “geometric” main axis 40. The main hinge 70 merges continually into the two film hinges 50 and 60.

The film hinges 50 and 60, which limit the connecting element 30, may be concave, convex or straight. Numerous additional shapes may be adopted. In the embodiment shown in FIGS. 1-6, the film hinges 50 and 60 meet at the main axis of the connecting element 30. In this embodiment, the film hinges 50 and 60 are merged into the main hinge 70 at the points they meet the main hinge 70. In another embodiment, the film hinges are continued to extend along the main hinge and are closely spaced apart in that region (not shown).

The main axis/film hinge design provides a dual-action closure 100. In a closed position, the flap is held in the closed position by a suitable detent mechanism, such as the snap-bead design as illustrated in FIGS. 1-6. When the detent mechanism has been opened, the flap automatically opens to a first angle between 0 to 90 degrees by pivoting along the main axis due to the resilient force from the main hinge 70 and/or the connecting element 30, which is bent in a closed position. The flap may further spring to a second angle between 90-180 degrees by a snap open mechanism using the resilient force of the film hinge 60.

The axial ends 32 and 34 of the connecting element 30 each have a U-shaped recession. The U-shaped recessions benefit the hinge structure in several ways.

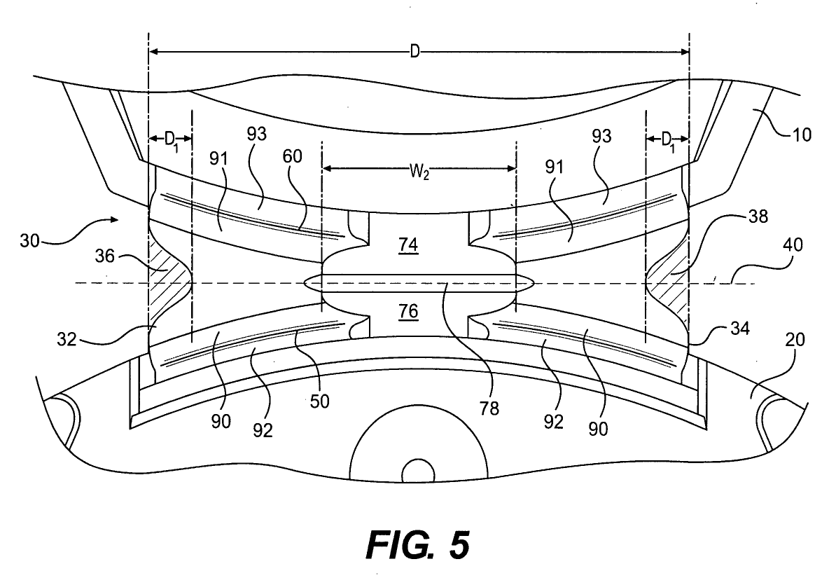

First, as shown in FIG. 5, shadowed areas 36 and 38 of a connecting element generally create the most “stress” or “stretch” in areas 90, 91, 92 and 93 when the living hinge 100 is actuated by opening or closing the hinge member 10 (i.e., the lid of the dispensing disclosure). The stress or stretch may weaken the areas and cause a crack or fracture that would soon extend through the connecting element 30, causing the hinge to fail when a consumer uses it. By removing the structure material in areas 36 and 38, the connecting element 30 is subjected to less stress in regions 90, 91, 92 and 93 at the top and bottom ends, which in turn minimizes the occurrence of hinge failure in the field.

Moreover, the U-shaped recessions at the top and bottom ends of the connecting element 30 allow for the film hinges 50 and 60 to be pulled tighter to the outside peripheral of the closure without reaching the stress limits of the structure material.

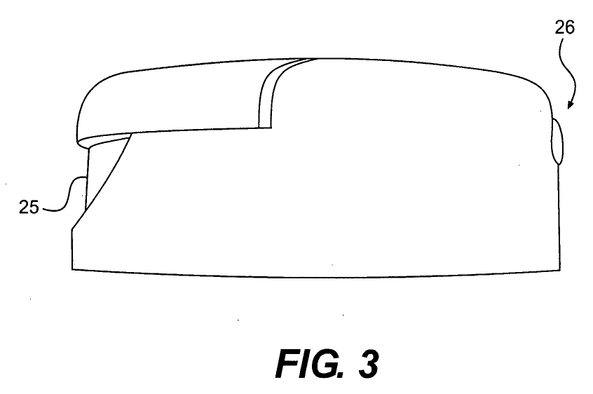

In addition, the U-shaped ends create a smooth transition/lead-in to the center section of the connecting element 30, which forms a smooth bulge 26 on the outer peripheral of the closure (FIG. 3). This smooth transition/lead-in allows customer assembly equipment like in-line wheel cappers to consistently torque the closure down without breaking down or tearing up the rubber wheels.

The exact shape and size of the U-shaped recessions at the axial ends 32 and 34 of the connecting element 30 may vary in each individual application and can be experimentally determined by a person of ordinary skill in the art. In one embodiment, the recessions have a depth (D₁) that is between 10% and 30% of the total length (D) of the living hinge 100.

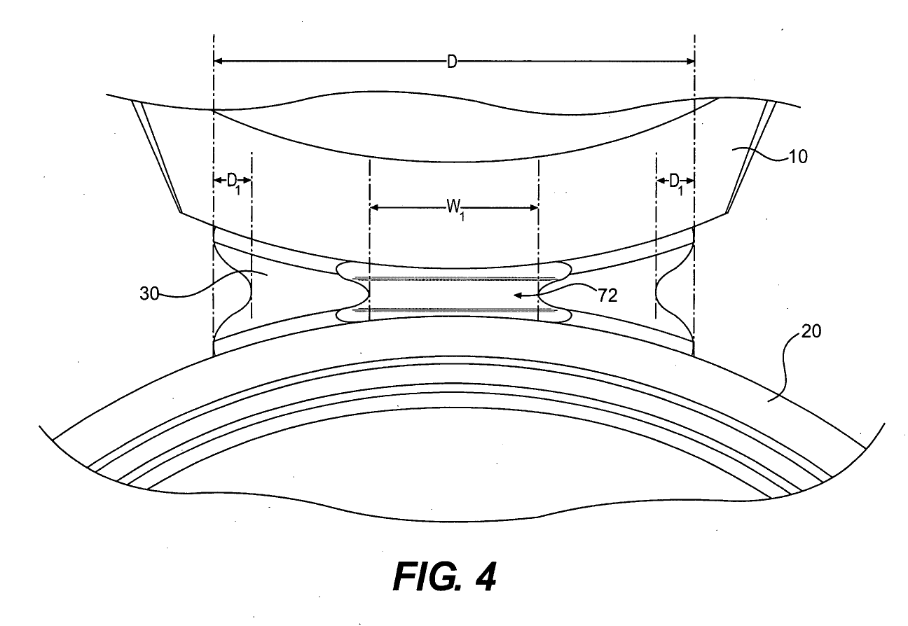

Referring now to FIGS. 4-6, there is shown an embodiment main hinge 70 that comprises a narrow, elongated reinforced area 72 in the center section on the exterior side of the connecting element 30 (FIG. 4). As used hereinafter, the “exterior side” refers to the side of the connecting element 30 that forms part of the exterior of the closure in a closed position. As shown in FIG. 5, the main hinge 70 may also contain reinforced connecting areas 74 and 76 to the hinge members 10 and 20, respectively, in the interior side of the connecting element 30. The reinforced connecting areas 74 and 76 are separated by a groove 78 along the “geometric” main axis 40.

The reinforced areas 74 and 76 provide strength and durability to the hinge about the axis of the hinge and ultimately allows for greater life cycles of the hinge. It also allows the formation of the U-shaped recessions on both ends of the connecting element 30 without weakening the overall strength of the hinge structure, which in turn allows for the hinge to be pulled tighter to the outer periphery of the closure. Finally, the reinforced areas can be designed to creates a smooth and blended region that protrudes from the outer periphery of the closure. Without reinforcement, this region of the main hinge 70 has a tendency of producing sharp edges when the flap is closed. These sharp edges can cause significant problems on the assembly equipment such as in-line wheel cappers. These cappers may get very torn up and broken down if this region of the closure has any sharp edges.

The exact shape and size of the reinforced areas 72, 74 and 76 in the connecting element 30 may vary in each individual application and can be experimentally determined by a person of ordinary skill in the art. In one embodiment, the reinforced areas have widths (W₁ and W₂) that are between 20% and 50% of the total length (D) of the living hinge 100. In another embodiment, the reinforced areas have widths (W₁ and W₂) that are between 30% and 40% of the total length (D) of the living hinge 100.

Referring again to FIGS. 1-3, the base 20 has a generally circular end wall 21 and a cylindrical skirt 22 depending from the periphery of the end wall. The skirt 22 is formed with internal threads enabling it to be screwed onto a mouth of a container. In one embodiment, a lower face or side of the end wall 21 includes a circumferentially continuous sealing surface that registers with and can engage the mouth of a bottle or container. A removable liner such as an induction seal liner, may be positioned in the base 20 against the sealing surface prior to assembly of the dispensing closure on a bottle to assure freshness and to provide tamper evidence by causing the liner to seal on the mouth of the container. The base 20 illustrated in FIGS. 1-3 has a relatively large pouring opening 23 on the end wall 21.

The flap 10 opens and closes the pouring opening 23. A releasable flap catch mechanism, such as the snap-bead design as illustrated, is provided to releasably hold the flap 10 closed on the end wall 21 to close the opening 23. The snap-bead catch mechanism includes a circular edge 24 on the end wall 21 and a complimentary inward curvature 12 on the edge of the flap 10 that snap catches the edge 24 when the flap 10 is in a closed position. The release of the flap 10 is facilitated by a thumbtab 25 formed on the cylindrical skirt 22 on the side opposite to the living hinge. In another embodiment, the opening 23 is surrounded by a circular guard wall and the flap catch mechanism involves an edge on the exterior of the guard wall and a complimentary inward curvature on the inside surface of flap 10.

Also disclosed is a container assembly. The container assembly includes a container having a dispensing opening and a dispensing closure with a dual-action living hinge attached to said dispensing opening. The dispensing closure includes a base; a lid, and a dual-action living hinge connecting the base to the lid.

In one embodiment, the dispensing closure is reversibly attached to the container.

In another embodiment, the dispensing closure is irreversibly attached to the container.

In another embodiment, the base includes an end wall with at least one opening on the end wall and a skirt extending downward from the periphery of the end wall.

While the invention has been shown and described with respect to particular embodiments thereof, this is for the purpose of illustration rather than limitation, and other variations and modifications of the specific embodiments herein shown and described will be apparent to those skilled in the art all within the intended spirit and scope of the invention. For example, the invention, besides being employed with screw-on caps such as disclosed herein, can also be employed with friction or adhesive retained or snap-on closures that fit on or in a container. Accordingly, the patent is not to be limited in scope and effect to the specific embodiments herein shown and described nor in any other way that is inconsistent with the extent to which the progress in the art has been advanced by the invention.

What is claimed is:

1. A dual action living hinge, comprising
a first hinge member and a second hinge member flexibly connected by a connecting element;
wherein said first and second hinge members are adapted to be folded about a geometric axis of said connecting element, wherein said connecting element comprises a recession at each axial end along said geometric axis and a reinforced area in a center section along said geometric axis.

2. The dual action living hinge of claim 1, wherein said first and second hinge members are connected to said connecting element by film living hinges.

3. The dual action living hinge of claim 1, wherein said recession is a U-shaped recession.

4. The dual action living hinge of claim 1, wherein said reinforced area is on an exterior side of said connecting element.

5. The dual action living hinge of claim 4, wherein said connecting element further comprises a reinforcing area on each side of said geometric axis on an interior side of said connecting element.

6. The dual action living hinge of claim 1, wherein said first hinge member comprises a flap and wherein said second hinge member comprises a base.

7. The dual action living hinge of claim 6, wherein said base comprises an end wall with an opening and a skirt.

8. The dual action living hinge of claim 7, wherein said skirt comprises internal threads.

9. The dual action living hinge of claim 7, wherein said end wall has an edge and said flap has an inward curvature to engage with said edge in a closed position.

10. The dual action living hinge of claim 9, wherein said skirt further comprises a thumbtab.

11. A one-piece dispensing closure, comprising
a base;
a lid; and
a connecting element connecting said base to said lid,
wherein said connecting element comprises:
a living hinge allowing said lid to move pivotally relative to said base along a geometric axis;
recessions at each axial end of said living hinge, and
a reinforced area in a center section along said geometric axis on the exterior side of said connecting element.

12. The one-piece dispensing closure of claim 11, wherein said recessions are U-shaped recessions.

13. The one-piece dispensing closure of claim 11, wherein said connecting element further comprises a first film living hinge connecting said connecting element to said lid, and a second film living hinge connecting said connecting element to said base.

14. The one-piece dispensing closure of claim 13, wherein said first and second film living hinges connect concavely to said lid and base.

15. The one-piece dispensing closure of claim 11, wherein said connecting element further comprises reinforced areas on the interior side of said connecting element.

16. The one-piece dispensing closure of claim 11, wherein said reinforced area is an elongated area extending in both directions along said geometric axis to the full length of said living hinge.

17. The one-piece dispensing closure of claim 11, wherein said base comprises an end wall with an opening and a skirt.

18. The one-piece dispensing closure of claim 17, wherein said skirt comprises internal threads.

19. The one-piece dispensing closure of claim 7, wherein said end wall comprises an edge and said flap has an inward curvature to engage with said edge in a closed position.

20. The one-piece dispensing closure of claim 19, wherein said skirt further comprises a thumbtab.
